(19) United States
(12) Patent Application Publication
(10) Pub. No.: US 2006/0165372 A1
(43) Pub. Date: Jul. 27, 2006

(54) Micromachined structure for valve and pump systems

(75) Inventors: Gwo-Bin Lee, Tainan City (TW); Chih-Hao Wang, Chung-Ho City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NATIONAL CHENG KUNG UNIVERSITY, Tainan City (TW)

(21) Appl. No.: 11/205,533

(22) Filed: Aug. 16, 2005

(30) Foreign Application Priority Data
Jan. 27, 2005 (TW) 094102500

(51) Int. Cl. G02B 6/00

(52) U.S. Cl. 385/147

(57) ABSTRACT

A micromachined structure includes: a first plate formed with a first groove; a second plate disposed over the first plate and formed with a second groove, the second groove meandering across the first groove so as to cooperate with the first groove to form at least two intersections; and an isolating member attached to and sandwiched between the first plate and the second plate and isolating the first groove from the second groove. The isolating member has at least two driving parts, each of which spans a respective one of the intersections, and each of which is flexible so as to be able to flex into the first groove at the respective one of the intersections when the pressure in the second groove is increased.

### CROSS-REFERENCE TO RELATED APPLICATION

This application claims priority of Taiwanese application no. 094102500, filed on Jan. 27, 2005.

### BACKGROUND OF THE INVENTION

1. Field of the Invention

The invention relates to a micromachined structure, more particularly to a micromachined structure for valve and pump systems.

2. Description of the Related Art

In a biomedical or a chemical analysis, the amount of a test sample or a reagent to be analyzed is normally very small, and must be measured accurately. As such, the device for measuring and delivering the amount of the test sample or the reagent must be small enough so as to reduce the measuring error and loss thereof.

U.S. Pat. Nos. 6,408,878 and 6,793,753 disclose micromachined structures, such as on/off valves, switching valves, and peristaltic pumps. The micromachined structure includes a straight flow channel covered with a membrane, and three gas channels traversing the flow channel for independently controlling movement of the membrane into the flow channel, thereby permitting peristaltic actions upon pressurization of the gas channels.

The aforesaid micromachined structure is disadvantageous in that the gas channels are separated from each other. As such, pressurization of the gas channels requires corresponding pressurizing devices or a complicated control system to carry out, which results in an increase in the manufacturing costs. In addition, pressure control of the gas channels is relatively complicated.

### SUMMARY OF THE INVENTION

Therefore, the object of the present invention is to provide a micromachined structure that can overcome the aforesaid drawbacks associated with the prior art.

Accordingly, there is provided a micromachined structure that comprises: a first plate having a first surface and formed with a first groove that is indented from the first surface and that is adapted to receive a liquid therein; a second plate disposed over the first plate, having a second surface that faces toward the first surface of the first plate, and formed with a second groove that is indented from the second surface and that is adapted to receive a gas therein, the second groove meandering across the first groove so as to cooperate with the first groove to format least two intersections; and an isolating member attached to and sandwiched between the first surface of the first plate and the second surface of the second plate and isolating the first groove from the second groove. The isolating member has at least two driving parts, each of which spans a respective one of the intersections, and each of which is flexible so as to be able to flex into the first groove at the respective one of the intersections when the pressure in the second groove is increased due to introduction of the gas into the second groove, thereby pushing the liquid in the first groove to move along the length of the first groove.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a first plate of a micromachined structure of the preferred embodiment according to the present invention;

FIG. 2 is a perspective view of a mold for preparing a second plate of the micromachined structure of the preferred embodiment;

FIG. 3 is a perspective view to illustrate how the second plate of the micromachined structure of the preferred embodiment is formed using the mold of FIG. 2;

FIG. 4 is an exploded perspective view of the preferred embodiment;

FIG. 5 is a schematic top view of the preferred embodiment;

FIG. 6 is a sectional view of the preferred embodiment; and

FIG. 7 is a plot of the relationship between the flow rate of a liquid and the frequency of a pulsating gas flow for micromachined structures, which respectively have different numbers of intersections formed thereon, according to the present invention, and for a conventional peristaltic pump.

### DETAILED DESCRIPTION OF THE PREFERRED EMBODIMENT

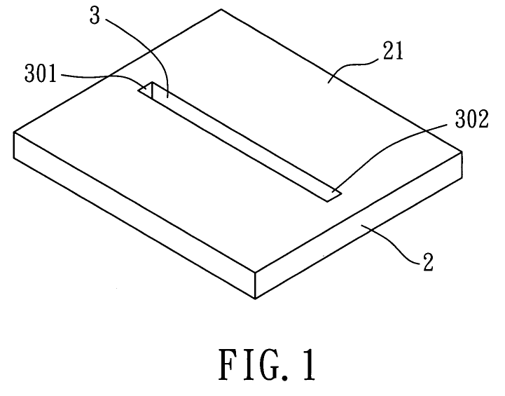

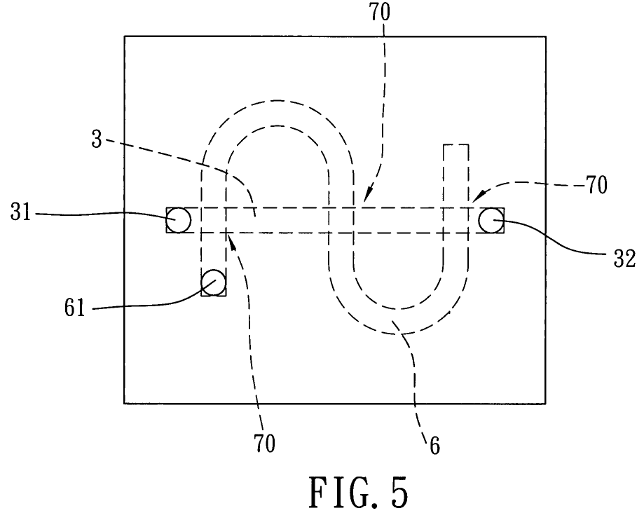

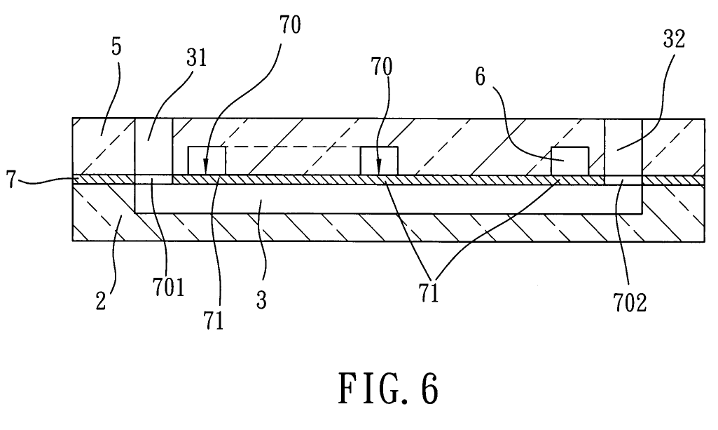

FIGS. 1 to 4 illustrate consecutive steps of a fabrication method for preparing a micromachined structure of the preferred embodiment (see FIGS. 5 to 6) according to the present invention. The method comprises the following steps:

a) Forming an elongated straight first groove 3 in a first plate 2 (see FIG. 1) by wet etching techniques: The first groove 3 is indented from a first surface 21 of the first plate 2 and is adapted for receiving a liquid therein. The first plate 2 is preferably made from glass, quartz, silicon, etc. The first groove 3 has opposite first and second ends 301, 302. In this embodiment, the first plate 2 is made from a polymer material, and the first groove 3 is formed using hot embossing techniques or injection molding techniques. Examples of the aforesaid polymer material includes polymethylmethacrylate (PMMA), polycarbonate (PC), polystyrene (PS), acrylonitrile-butadiene-styrene (ABS), and polydimethylsiloxane (PDMS).

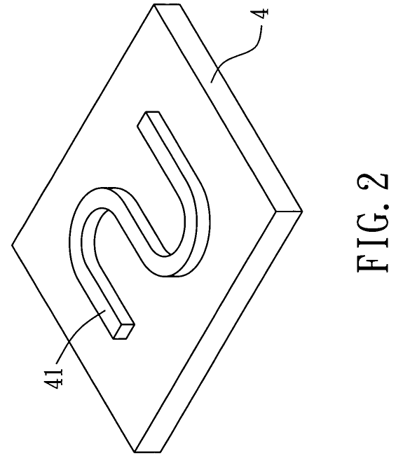

b) Preparing a mold 4 with a tortuous protrusion 41 (see FIG. 2) which has a continuously curved shape and which is S-shaped in this embodiment.

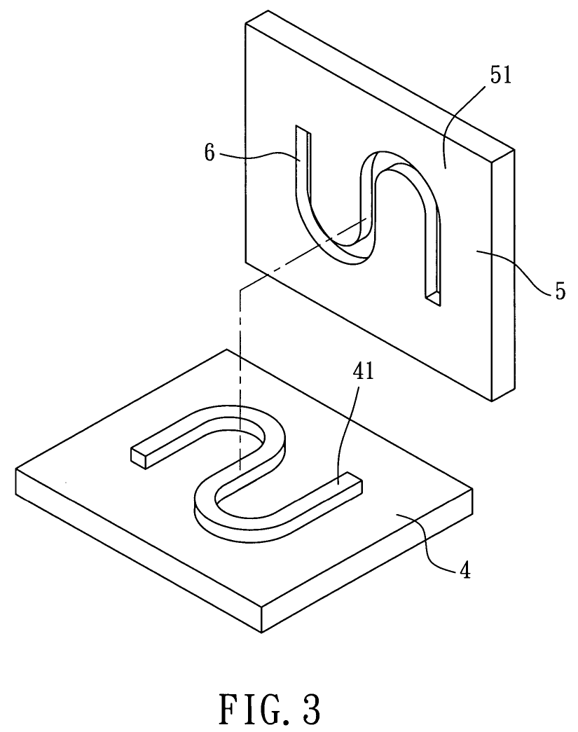

c) Forming a second plate 5 by applying a polymer material to the mold 4 such that a S-shaped second groove 6 corresponding to the tortuous protrusion 41 is formed in and is indented from a second surface of the second plate 5 (see FIG. 3). The second groove 6 is adapted for receiving a gas therein.

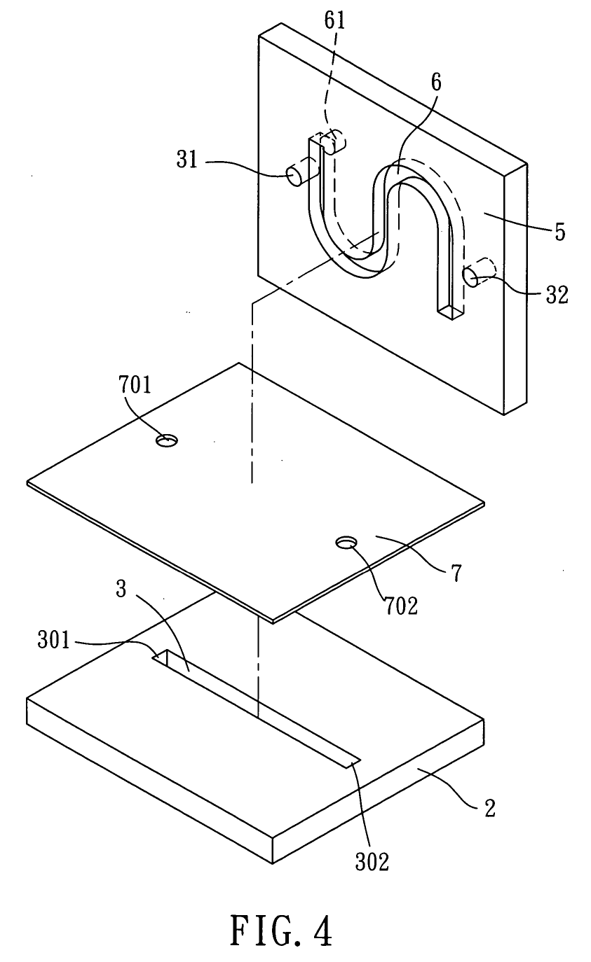

d) Sandwiching an isolating member 7 between the first surface 21 of the first plate 2 and the second surface 51 of the second plate 5 (see FIG. 4) such that the first groove 3 is isolated from the second groove 6 through the isolating member 7 and that the second groove 6 meanders across the first groove 3 so as to cooperate with the first groove 3 to format least two intersections 70 (while three intersections 70 are formed in this embodiment, see FIG. 5, the number of the intersections 70 can be increased in accordance with actual operating requirements). The isolating member 7 has at least two driving parts 71 (see FIG. 6), each of which spans a respective one of the intersections 70, and each of which is flexible so as to be able to flex into the first groove 3 at the respective one of the intersections 70 when the pressure in the second groove 6 is increased due to introduction of the gas into the second groove 6, thereby pushing the liquid in the first groove 3 to move along the length of the first groove 3. The micromachined structure thus formed is suitable for application to a biochip.

In this embodiment, the isolating member 7 is in the form of a membrane that has portions, which are disposed at the intersections 70, and which are able to flex without constriction as compared to the remaining portion of the membrane which is in contact with the first surface 21 of the first plate 2 and the second surface 51 of the second plate 5. The unrestricted portions of the membrane define the driving parts 71, respectively.

A gas inlet 61 is formed in the second plate 5, is in fluid communication with the second groove 6, and is adapted to be connected to a gas supplying source (not shown), which is one that can supply pulsating gas flow so as to result in a peristaltic pumping action through continuous alternating contraction and expansion of the driving parts 71 of the isolating member 7. Formation of the gas inlet 61 can be performed by drilling using a micro driller or using a removable insert during formation of the second plate 5 using the mold 4.

The isolating member 7 is formed with first and second through-holes 701, 702 that are registered with the first and second ends 301, 302 of the first groove 3, respectively. The second plate 5 is further formed with a liquid inlet 31 and a liquid outlet 32, which are registered with the first and second through-holes 701, 702 in the isolating member 7, respectively, so as to permit flow of the liquid from the liquid inlet 31 through the first groove 3 and the liquid outlet 32 when the pressure in the second groove 6 is increased.

The preferred embodiment of this invention is adapted for connection to a pulsating gas pressure source (not shown) for driving small amounts of fluid. The pulsating gas pressure source may include a compressor, a gas pressure valve and a control circuit for controlling the gas pressure valve. The frequency of a pulsating gas flow to be delivered into the second groove 6 by the pulsating gas pressure source can be adjusted by a controller (not shown) according to the flow rate of the liquid needed to be delivered.

The driving parts 71 of the isolating member 7 flex into the first groove 3 at the intersections 70 to push the liquid in the first groove 3 to flow along the length of the first groove 3 in a direction toward the liquid outlet 32. Due to a delay effect during movement of the gas flow along the second groove 6, the driving parts 71 of the isolating member 7 flex into the first groove 3 at the intersections 70 in a progressive sequence.

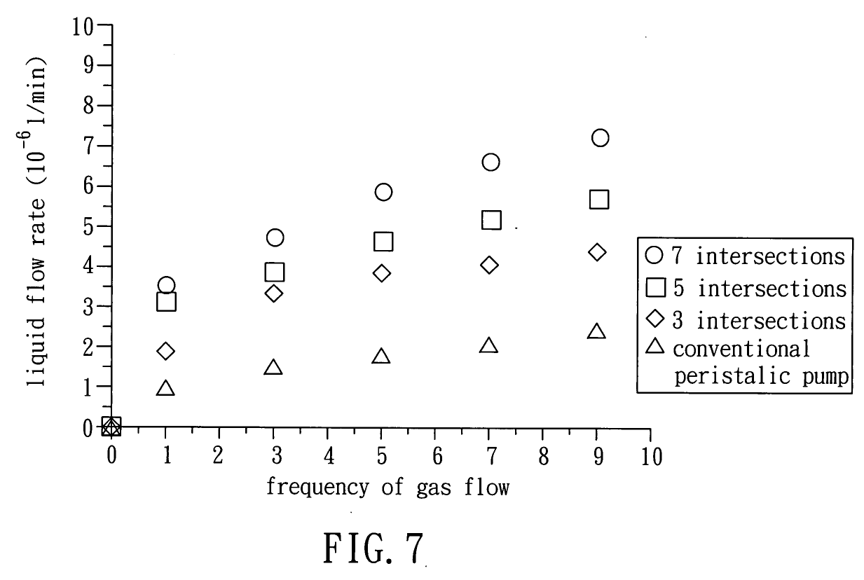

FIG. 7 illustrates the relationship between the flow rate of the liquid in the first groove 3 and the frequency of the pulsating gas flow delivered into the second groove 6 for micromachined structures, which respectively have different numbers of intersections formed thereon, i.e., seven, five, and three intersections 70, respectively, according to the present invention, and for a conventional peristaltic pump. The results show that the higher the number of the intersections 70, the larger will be the liquid flow rate in the first groove 3 under the same driving pressure acting on the driving parts 71 of the isolating member 7. In addition, the liquid flow rate in the first groove 3 exhibits a linearly proportional relationship with the frequency of the pulse movement of the gas flow into the second groove 6.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A micromachined structure comprising:
a first plate having a first surface and formed with a first groove that is indented from said first surface and that is adapted to receive a liquid therein;
a second plate disposed over said first plate, having a second surface that faces toward said first surface of said first plate, and formed with a second groove that is indented from said second surface and that is adapted to receive a gas therein, said second groove meandering across said first groove so as to cooperate with said first groove to form at least two intersections; and
an isolating member attached to and sandwiched between said first surface of said first plate and said second surface of said second plate and isolating said first groove from said second groove, said isolating member having at least two driving parts, each of which spans a respective one of said intersections, and each of which is flexible so as to be able to flex into said first groove at the respective one of said intersections when the pressure in said second groove is increased due to introduction of the gas into said second groove, thereby pushing the liquid in said first groove to move along the length of said first groove.

2. The micromachined structure as claimed in claim 1, wherein said first groove is elongated and straight.

3. The micromachined structure as claimed in claim 2, wherein said isolating member is in the form of a membrane that has at least two portions, each of which defines a respective one of said driving parts.

4. The micromachined structure as claimed in claim 3, wherein said second plate is formed with a gas inlet that is in fluid communication with said second groove and that is adapted to be connected to a gas supplying source.

5. The micromachined structure as claimed in claim 4, wherein said first groove has opposite first and second ends, said membrane being formed with first and second through-holes that are registered with said first and second ends of said first groove, respectively, said second plate being further formed with a liquid inlet and a liquid outlet, which are registered with said first and second through-holes in said membrane, respectively, so as to permit flow of the liquid from said liquid inlet through said first groove and said liquid outlet when the pressure in said second groove is increased.
